(19) United States
(12) Patent Application Publication
(10) Pub. No.: US 2023/0160081 A1
(43) Pub. Date: May 25, 2023

(54) Carbon Dioxide Gas-Phase Reduction Device and Method for Producing Porous Electrode-Supported Electrolyte Membrane

(71) Applicant: Nippon Telegraph and Telephone Corporation, Tokyo (JP)

(72) Inventors: Sayumi Sato, Musashino-shi, Tokyo (JP); Yuya Uzumaki, Musashino-shi, Tokyo (JP); Yoko Ono, Musashino-shi, Tokyo (JP); Takeshi Komatsu, Musashino-shi, Tokyo (JP)

(21) Appl. No.: 17/918,061

(22) PCT Filed: May 21, 2020
(86) PCT No.: PCT/JP2020/020113

§ 371 Date: Oct. 10, 2022

(51) Int. Cl. C25B 3/26; C25B 13/00; C25B 9/19

(52) U.S. Cl. CPC C25B 3/26; C25B 13/00; C25B 9/19

(57) ABSTRACT

A gas phase reduction apparatus of carbon dioxide includes an oxidation chamber that includes an oxidation electrode; a reduction chamber that is adjacent to the oxidation chamber and receives supplied carbon dioxide; and a porous electrode-supporting electrolyte membrane that is placed between the oxidation chamber and the reduction chamber. The porous electrode-supporting electrolyte membrane is a joined body including a porous reduction electrode joined to an electrolyte membrane. The electrolyte membrane is placed on the oxidation chamber side. The porous reduction electrode is placed on the reduction chamber side and configured to reduce the carbon dioxide by electrons from the oxidation electrode connected via a conductor.

### TECHNICAL FIELD

The present invention relates to a gas phase reduction apparatus of carbon dioxide and a method for producing a porous electrode-supporting electrolyte membrane.

### BACKGROUND ART

Up to now, a technique for reducing carbon dioxide has been gathering attention from the perspective of preventing global warming and stably supplying energy. As apparatuses relating to the technique for reducing carbon dioxide, there are reduction apparatuses utilizing an artificial light synthetic technique of applying light energy and reducing carbon dioxide and electric decomposition apparatuses applying electrical energy and reducing carbon dioxide (see NPL 1-4).

For example, carbon dioxide reduction apparatuses using light irradiation are illustrated in FIG. 2 of NPL 3 and FIG. 1 of NPL 4. An electrolyte membrane (CEM) is placed between the left-side oxidation chamber and the right-side reduction chamber, and the oxidation chamber and the reduction chamber are each filled with an aqueous solution. An oxidation electrode of gallium nitride (GaN) is put in the oxidation chamber, the reduction electrode of copper (Cu) is put in the reduction chamber, and the oxidation electrode and the reduction electrode are connected via a conductor. Then, helium (He) is made to flow into the aqueous solution in the oxidation chamber, and carbon dioxide (CO₂) is made to flow into the aqueous solution in the reduction chamber.

At this time, when the oxidation electrode is irradiated with light, spatial separation of electron-hole pairs occurs on the oxidation electrode, and oxygen (O₂) and proton (H⁺) are formed by the oxidation reaction of water (H₂O). The electrons formed on the oxidation electrode move to the reduction electrode via a conductor, and the protons move to the reduction chamber via an electrolyte membrane. After that, a hydrogen (H₂) formation reaction between a proton and an electron and a reduction reaction of carbon dioxide among a proton, an electron, and carbon dioxide are caused on the reduction electrode. This reduction reaction forms carbon monoxide or the like, which is used as an energy resource.

### CITATION LIST

### Non Patent Literature

[NPL 1] Yoshio Hori, two others, “Formation of Hydrocarbons in the Electrochemical Reduction of Carbone Dioxide at a Copper Electrode in Aqueous Solution”, Journal of the Chemical Society, 85(8), 1989, p. 2309-p. 2326

[NPL 2] Heng Zhong, two others, “Effect of KHCO3 Concentration on Electrochemical Reduction of CO2 on Copper Electrode”, The Electrochemical Society 164(9), 2017, p. F923-p. F927

[NPL 3] Satoshi Yotsuhashi, six others, “CO2 Conversion with Light and Water by GaN Photoelectrode”, Japanese Journal of Applied Physics, 51, 2012, p. 02BP07-1-p.02BP07-3

[NPL 4] Hiroshi Hashiba, four others, “Selectivity Control of CO2 Reduction in an Inorganic Artificial Photosynthesis System”, Applied Physics Express, 6, 2013, p. 097102-1-p. 097102-4

### SUMMARY OF THE INVENTION

### Technical Problem

Carbon dioxide, a target to be reduced, is dissolved in an aqueous solution in a reduction chamber, reaches the reduction electrode, and is reduced on the surface of a reduction electrode. However, a conventional carbon dioxide supply method, which uses an aqueous solution as mediational means of carbon dioxide, has a limit to the concentration of carbon dioxide that can be dissolved in the aqueous solution, and the diffusion resistance of carbon dioxide in the aqueous solution is large. Therefore, there is a limit to the amount of carbon dioxide that can be supplied to the reduction electrode.

Therefore, there is a problem of enhancing the efficiency of the reduction reaction of carbon dioxide on the reduction electrode by increasing the carbon dioxide concentration in the reduction chamber and reducing the diffusion resistance of carbon dioxide, and consequently increasing the supply amount of carbon dioxide to the reduction electrode.

The present invention has been made in consideration of the above state, and an object of the present invention is to provide a technique that can enhance the efficiency of the reduction reaction of carbon dioxide on a reduction electrode.

### Means for Solving the Problem

A gas phase reduction apparatus of carbon dioxide of one aspect of the present invention includes an oxidation chamber that includes an oxidation electrode; a reduction chamber that is adjacent to the oxidation chamber and receives supplied carbon dioxide; and a porous electrode-supporting electrolyte membrane that is placed between the oxidation chamber and the reduction chamber. The porous electrode-supporting electrolyte membrane is a joined body including a porous reduction electrode joined to an electrolyte membrane. The electrolyte membrane is placed on the oxidation chamber side. The porous reduction electrode is placed on the reduction chamber side and configured to reduce carbon dioxide by electrons from the oxidation electrode connected via a conductor.

A method for producing a porous electrode-supporting electrolyte membrane for carbon dioxide of one aspect of the present invention is a method for producing a porous electrode-supporting electrolyte membrane used in a gas phase reduction apparatus of carbon dioxide. The gas phase reduction apparatus of carbon dioxide includes an oxidation chamber that includes an oxidation electrode; a reduction chamber that is adjacent to the oxidation chamber and receives supplied carbon dioxide; and a porous electrode-supporting electrolyte membrane that is placed between the oxidation chamber and the reduction chamber. The porous electrode-supporting electrolyte membrane is a joined body including a porous reduction electrode joined to an electrolyte membrane. The electrolyte membrane is placed on the oxidation chamber side. The porous reduction electrode is placed on the reduction chamber side and configured to reduce carbon dioxide by electrons from the oxidation electrode connected via a conductor. The method includes: a first step of coating an electrolyte dispersion on a surface of the electrolyte membrane; a second step of thermally treating the electrolyte dispersion to form a joining material of an identical component to the electrolyte membrane on a surface of the electrolyte membrane; and a third step of superimposing the porous reduction electrode on a surface of the joining material and applying pressure on the porous reduction electrode while heating such that the electrolyte membrane and the porous reduction are joined together.

### Effects of the Invention

The present invention can provide a technique that can enhance the efficiency of the reduction reaction of carbon dioxide on a reduction electrode.

### BRIEF DESCRIPTION OF DRAWINGS

FIG. 1 is a configuration diagram illustrating a gas phase reduction apparatus of carbon dioxide according to example 1.

FIG. 2 is a view illustrating a method for constructing a porous electrode-supporting electrolyte membrane.

FIG. 3 is a sectional view illustrating a section of a porous electrode-supporting electrolyte membrane.

FIG. 4 is a configuration diagram illustrating a constitution of a gas phase reduction apparatus of carbon dioxide according to Example 10.

FIG. 5 is a configuration diagram illustrating a constitution of a gas phase reduction apparatus of carbon dioxide according to comparison target example 1.

FIG. 6 is a configuration diagram illustrating a constitution of a gas phase reduction apparatus of carbon dioxide according to comparison target example 2.

### DESCRIPTION OF EMBODIMENTS

Embodiments of the present invention are described below with reference to the drawings. In the drawings, the same symbol or numeral is assigned to the same component and the descriptions on such components are omitted. The present invention is not limited to the embodiments disclosed in Examples and can be modified without departing from the spirit of the present invention.

### SUMMARY OF THE INVENTION

The invention relates to a gas phase reduction apparatus of carbon dioxide, causing the reduction reaction of carbon dioxide by light irradiation or the electrolytic reduction reaction of carbon dioxide and enhancing the efficiency of the reduction reaction. The present invention belongs to the field of fuel fabrication techniques, solar energy conversion techniques, and carbon dioxide fixation techniques.

As stated about the above problem, aqueous solutions have conventionally been used as mediational means of carbon dioxide. On the contrary, in the present invention, a reduction chamber is filled with gas phase carbon dioxide, and the gas phase carbon dioxide is then directly supplied to a reduction electrode in order to increase the carbon dioxide concentration and reduce the diffusion resistance of carbon dioxide.

In this case, three-phase interfaces of [electrolyte membrane/reduction electrode/gas phase carbon dioxide] are required for achieving the reduction reaction of carbon dioxide. However, protons passing through the electrolyte membrane cannot move in the gas phase of the reduction chamber, and therefore, do not reach the reduction electrode. Thus, the electrolyte membrane and the reduction electrode are brought into contact and joined with each other in the present invention.

Furthermore, carbon dioxide cannot move in a poreless reduction electrode. Thus, a reduction electrode with pores is used in the present invention.

That is, the present invention has a constitution wherein gas phase carbon dioxide is directly supplied to a porous electrode-supporting electrolyte membrane obtained by joining a porous reduction electrode to an electrolyte membrane. According to this constitution, the enhancement of the efficiency of the reduction reaction of carbon dioxide on the reduction electrode can be achieved.

### Example 1

### Constitution of Gas Phase Reduction Apparatus of Carbon Dioxide

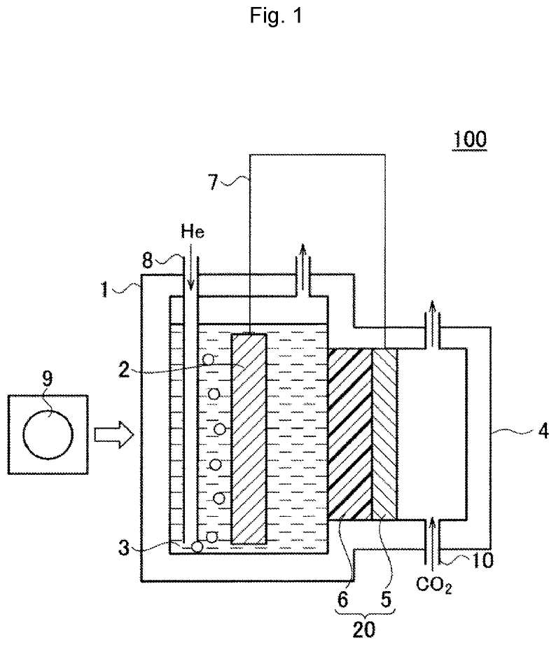

FIG. 1 is a configuration diagram illustrating a constitution of a gas phase reduction apparatus 100 of carbon dioxide according to example 1. The gas phase reduction apparatus 100 of carbon is a reduction apparatus utilizing an artificial light synthetic technique of applying light energy and reducing carbon dioxide. The reduction apparatus is hereinafter abbreviated as a gas phase reduction device 100.

The gas phase reduction device 100 includes an oxidation chamber 1 and a reduction chamber 4 formed by separating the inner space of one housing into two compartments. The oxidation chamber 1 is filled with an aqueous solution 3, and an oxidation electrode 2 composed of a semiconductor or a metal complex is inserted into the aqueous solution 3. The reduction chamber 4 is adjacent to the oxidation chamber 1. The reduction chamber 4 is not filled with an aqueous solution but filled with gas phase carbon dioxide supplied from the exterior.

The oxidation electrode 2 is composed of a compound exhibiting an optical activity or a redox activity, for example, a nitride semiconductor, titanium oxide, amorphous silicon, a ruthenium complex, or a rhenium complex.

The aqueous solution 3 is, for example, an aqueous potassium hydrogen carbonate solution, an aqueous sodium hydrogen carbonate solution, an aqueous potassium chloride solution, an aqueous sodium chloride solution, an aqueous sodium hydroxide solution, an aqueous potassium hydroxide solution, an aqueous rubidium hydroxide solution, or an aqueous cesium hydroxide solution.

The gas phase reduction device 100 further includes a porous electrode-supporting electrolyte membrane 20 placed between the oxidation chamber 1 and the reduction chamber 4. The porous electrode-supporting electrolyte membrane 20 is a joined body forming walls between the oxidation chamber 1 and the reduction chamber 4 and having an electrolyte membrane 6 and a porous reduction electrode 5 directly joined to the electrolyte membrane 6. The electrolyte membrane 6 is placed on the oxidation chamber 1 side, and the porous reduction electrode 5 is placed on the reduction chamber 4 side.

The porous reduction electrode 5 is an electrode having a plurality of small pores. The porous reduction electrode 5 is, for example, copper, platinum, gold, silver, indium, palladium, gallium, nickel, tin, or cadmium. The porous reduction electrode 5 may be an alloy of these metals. The porous reduction electrode 5 may be a metal oxide such as silver oxide, copper (I) oxide, copper (II) oxide, nickel oxide, indium oxide, tin oxide, tungsten oxide, or tungsten (VI) oxide. The porous reduction electrode 5 may be a porous metal complex including a metal ion and an anionic ligand.

The electrolyte membrane 6 is, for example, an electrolyte membrane having carbon-fluorine skeletons such as Nafion (registered trademark), FORBLUE S series, or Aquivion.

The oxidation electrode 2 and the porous reduction electrode 5 of the porous electrode-supporting electrolyte membrane 20 are connected via a conductor 7. The porous reduction electrode 5 reduces carbon dioxide in the reduction chamber 4 by electrons from the oxidation electrode 2 moved via the conductor 7.

For operating the gas phase reduction device 100, a light source 9 for irradiating the oxidation electrode 2 with light is placed so as to face the oxidation electrode 2. The light source 9 is, for example, a xenon lamp, a simulated solar light source, a halogen lamp, a mercury lamp, or a solar light. The light source 9 may be configured as a combination of these light sources.

### Operation Overview of Gas Phase Reduction Apparatus of Carbon Dioxide

Helium (He) is made to flow into the aqueous solution in the oxidation chamber 1, and carbon dioxide (CO₂) is made to flow into the aqueous solution in the reduction chamber 4. At this time, when the oxidation electrode 2 is irradiated with light from the light source 9, spatial separation of electron-hole pairs occurs on the oxidation electrode 2, and oxygen (O₂) and proton (H⁺) are formed by the oxidation reaction of water (H₂O). Then, the electrons formed on the oxidation electrode 2 move to the porous reduction electrode 5 via the conductor 7, and the protons reach the porous reduction electrode 5 via the electrolyte membrane 6. After that, in the porous reduction electrode 5, a hydrogen (H₂) formation reaction between a proton and an electron and a reduction reaction of carbon dioxide among a proton, an electron, and carbon dioxide occurs. This reduction reaction forms carbon monoxide or the like, which is used as an energy resource.

### Method for Constructing Porous Electrode-Supporting Electrolyte Membrane

In Example 1, a copper Celmet with a thickness of about 1.5 mm and a porosity of about 96% was used as a porous metal plate that served as the porous reduction electrode 5. As the electrolyte membrane 6, a cation exchange membrane, Nafion, was used. As an electrolyte dispersion for joining, a dispersion prepared by diluting a Nafion dispersion with a Nafion content of 20% to 22% with 2-propanol such that the ratio (Nafion dispersion):(2-propanol) be 4:1. The solvent used for dilution is pure water, a lower alcohol, or a mixture of these. 2-Propanol was used in Example 1.

### First Step:

First, Nafion is dipped in boiling nitric acid and then boiling pure water. Then, an electrolyte dispersion in which a polymer material is dispersed is coated on the Nafion using a casting method with a thickness of about 150 μm.

### Second Step:

Next, the Nafion (electrolyte dispersion coated on Nafion) is heated and dried by standing the Nafion on a hotplate at about 120° C. for about 10 minutes to form a joining material composed of an identical material and component to Nafion.

### Third Step:

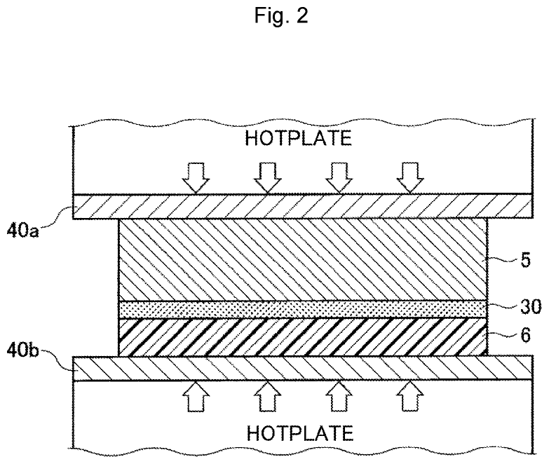

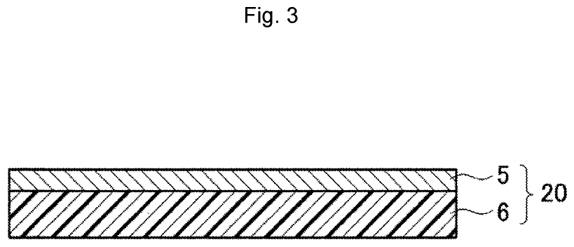

Finally, a copper Celmet is superimposed on the joining material and the pressure is applied to the Nafion while being heated to construct a porous electrode-supporting electrolyte membrane 20. The schematic view of this thermocompression bonding method is illustrated in FIG. 2. The electrolyte membrane (Nafion) 6, a joining material 30, and the porous reduction electrode (Celmet) 5 were stacked in this order from the above in the vertical direction and placed between two copper plates 40a and 40b. Then, this stacked body was set in a thermocompression bonding apparatus (hot press machine), and pressure in a vertically downward direction on the paper surface was applied to the porous reduction electrode 5 in a heating temperature condition of about 30° C., and if necessary, a pressure in a vertically upward direction on the paper surface was applied to the electrolyte membrane 6, and the stacked body was still stood for 30 minutes. After that, the stacked body was rapidly cooled and taken out to obtain a porous electrode-supporting electrolyte membrane 20 in which the electrolyte membrane 6 and the porous reduction electrode 5 were directly joined, as illustrated in FIG. 3. The thickness of the porous reduction electrode 5 after the thermocompression bonding was about 1.0 mm (about 1.5 mm before the thermocompression bonding), and the porosity was about 94% (about 96% before the thermocompression bonding).

### Electrochemical Measurement and Measurement of Gas/Liquid Formation Amount

The oxidation chamber 1 is filled with the aqueous solution 3, and the oxidation electrode 2 is inserted into the aqueous solution 3. A substrate (NiO/AlGaN thin film/n-GaN thin film/sapphire substrate) obtained by epitaxially growing, on a sapphire substrate, an n-type semiconductor gallium nitride (n-GaN) and aluminum gallium nitride (AlGaN) in this order, vacuum-depositing nickel (Ni) thereon, and heating the nickel to form a co-catalyst thin film of nickel oxide (NiO) was used as the oxidation electrode 2 and set in the oxidation chamber 1 so as to be dipped in the aqueous solution 3. The aqueous solution 3 was a 1-mol/L aqueous potassium hydroxide (KOH) solution. A 300-W high-pressure xenon lamp (wavelength of 450 nm or larger was cut off, the illuminance of the wavelength of 365 nm or shorter: 6.6 mW/cm²) was used as the light source 9 and fixed so that the NiO-formed surface of the oxidation electrode 2 was to serve as the irradiated surface. The light irradiation area (light-receiving area) of the oxidation electrode 2 was set to about 2.5 cm².

Helium (He) is made to flow into the oxidation chamber 1 from a tube 8, and carbon dioxide (CO₂) is made to flow into the reduction chamber 4 from a gas inlet 10. The flow rate of each gas was set to about 5 ml/min, and the pressure was set to about 0.18 MPa. In this system, the electrolyte membrane 6 was directly joined to the porous reduction electrode 5, and the porous reduction electrode 5 had a plurality of small pores. Thus, the reduction reaction of carbon dioxide can be progressed in a three-phase interface composed of [electrolyte membrane 6/porous reduction electrode 5/gas phase carbon dioxide] in the porous electrode-supporting electrolyte membrane 20.

The oxidation chamber 1 and the reduction chamber 4 were sufficiently purged with helium and carbon dioxide, respectively. Then, the oxidation electrode 2 was uniformly irradiated with light using the light source 9. Electrons flew between the oxidation electrode 2 and the porous reduction electrode 5 by this light irradiation. At any given time during the light irradiation, gas and liquid in the oxidation chamber 1 and the reduction chamber 4 were collected, and the reaction products were analyzed using a gas chromatograph, a liquid chromatograph, and a gas chromatograph mass spectrometer. As a result, it was found that oxygen was formed in the oxidation chamber 1, and hydrogen, carbon monoxide, formic acid, methane, methanol, ethanol, and ethylene were formed in the reduction chamber 4. Furthermore, the current value between the oxidation electrode 2 and the porous reduction electrode 5 during the light irradiation was measured by an electrochemical measuring device (manufactured by Solartron, a 1287-type potentio-galvanostat).

### Example 2

In Example 2, the heating temperature in the third step was set to about 60° C. in the method for constructing a porous electrode-supporting electrolyte membrane according to Example 1. The porosity of the porous reduction electrode 5 was about 94%. Other conditions were all the same as Example 1.

### Example 3

In Example 3, the heating temperature in the third step was set to about 90° C. in the method for constructing a porous electrode-supporting electrolyte membrane according to Example 1. The porosity of the porous reduction electrode 5 was about 94%. Other conditions were all the same as Example 1.

### Example 4

In Example 4, the heating temperature in the third step was set to about 120° C. in the method for constructing a porous electrode-supporting electrolyte membrane according to Example 1. The porosity of the porous reduction electrode 5 was about 94%. Other conditions were all the same as Example 1.

### Example 5

In Example 5, the heating temperature in the third step was set to about 150° C. in the method for constructing a porous electrode-supporting electrolyte membrane according to Example 1. The porosity of the porous reduction electrode 5 was about 94%. Other conditions were all the same as Example 1.

### Example 6

In Example 6, the heating temperature in the third step was set to about 180° C. in the method for constructing a porous electrode-supporting electrolyte membrane according to Example 1. The porosity of the porous reduction electrode 5 was about 94%. Other conditions were all the same as Example 1.

### Example 7

In Examples 7, a copper Celmet with a thickness of about 1.5 mm and a porosity of about 36% was used as the porous metal plate that served as the porous reduction electrode 5 in the constructing method of a porous electrode-supporting electrolyte membrane according to Example 1. The heating temperature in the third step was set to about 120° C. The porous reduction electrode 5 after the thermocompression bonding had a thickness of about 1.0 mm and a porosity of about 4%. Other conditions were all the same as Example 1. The porosity after the thermocompression bonding was calculated using the following formula (1) because the thickness was changed from 1.5 mm to 1 mm by thermocompression bonding.

100−{1.5×(100−φ)} (1)

φ denotes the porosity before thermocompression bonding.

### Example 8

In Examples 8, a copper Celmet with a thickness of about 1.5 mm and a porosity of about 56% was used as the porous metal plate that served as the porous reduction electrode 5 in the constructing method of a porous electrode-supporting electrolyte membrane according to Example 1. The heating temperature in the third step was set to about 120° C. The porous reduction electrode 5 after the thermocompression bonding had a thickness of about 1.0 mm and a porosity of about 34%. Other conditions were all the same as Example 1.

### Example 9

In Examples 9, a copper Celmet with a thickness of about 1.5 mm and a porosity of about 86% was used as the porous metal plate that served as the porous reduction electrode 5 in the constructing method of a porous electrode-supporting electrolyte membrane according to Example 1. The heating temperature in the third step was set to about 120° C. The porous reduction electrode 5 after the thermocompression bonding had a thickness of about 1.0 mm and a porosity of about 64%. Other conditions were all the same as Example 1.

### Example 10

### Constitution of Gas Phase Reduction Apparatus of Carbon Dioxide

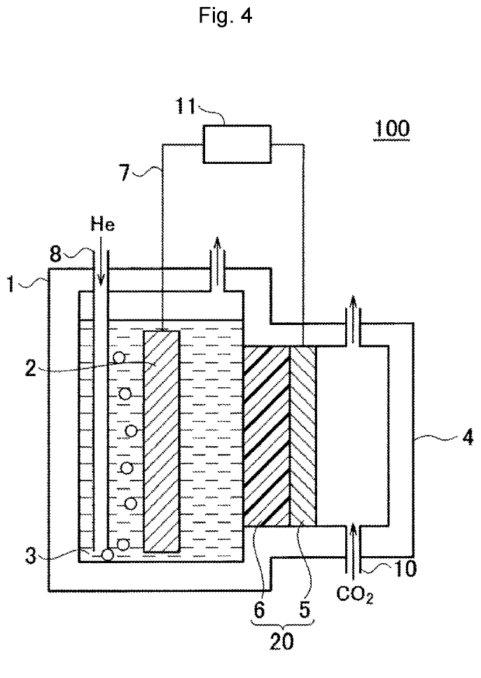

FIG. 4 is a configuration diagram illustrating a constitution of a gas phase reduction apparatus 100 of carbon dioxide according to Example 10. This gas phase reduction apparatus 100 of carbon dioxide is an electrolyzer that reduces carbon dioxide by applying electrical energy instead of light energy such as the irradiation light described in Examples 1. The reduction apparatus is hereinafter abbreviated as a gas phase reduction device 100.

In Examples 10, a power source 11 was used instead of the light source 9. The power source 11 is a power source for operating the gas phase reduction device 100 and connected to the conductor 7 between the oxidation electrode 2 and the porous reduction electrode 5. Furthermore, in Example 10, it was not required to exhibit the light catalyst function for exciting light on the oxidation electrode 2. Thus, the oxidation electrode 2 is constituted by, for example, platinum, gold, silver, copper, indium, or nickel.

Other conditions were all the same as Example 1. That is, the reduction chamber 4 is not filled with an aqueous solution but filled with gas phase carbon dioxide supplied from the exterior, also in Example 10. Furthermore, the porous electrode-supporting electrolyte membrane 20 in which the porous reduction electrode 5 is directly joined to the electrolyte membrane 6 is placed between the oxidation chamber 1 and the reduction chamber 4. The porous reduction electrode 5 is an electrode having a plurality of small pores. The method for constructing the porous electrode-supporting electrolyte membrane 20 was the same as Example 1.

### Electrochemical Measurement and Measurement of Gas/Liquid Formation Amount

The oxidation chamber 1 is filled with the aqueous solution 3, and the oxidation electrode 2 is inserted into the aqueous solution 3. A platinum oxidation electrode (manufactured by Nilaco) was used as the oxidation electrode 2 and set in the oxidation chamber 1 so that a surface area of about 0.55 cm² was dipped in the aqueous solution 3. The aqueous solution 3 was a 1-mol/L aqueous potassium hydroxide (KOH) solution.

Helium (He) is made to flow into the oxidation chamber 1 from a tube 8, and carbon dioxide (CO₂) is made to flow into the reduction chamber 4 from a gas inlet 10. The flow rate of each gas was set to about 5 ml/min, and the pressure was set to about 0.18 MPa. Also, in this system, the electrolyte membrane 6 was directly joined to the porous reduction electrode 5, and the porous reduction electrode 5 had a plurality of small pores. Thus, the reduction reaction of carbon dioxide can be progressed in a three-phase interface composed of [electrolyte membrane 6/porous reduction electrode 5/gas phase carbon dioxide] in the porous electrode-supporting electrolyte membrane 20. The area of the porous reduction electrode 5 to which carbon dioxide was directly supplied was set to about 6.25 cm².

The oxidation chamber 1 and the reduction chamber 4 were sufficiently purged with helium and carbon dioxide, respectively. Then, power source 11 was connected between the oxidation electrode 2 and the porous reduction electrode 5 with the conductor 7, and the voltage of 2.5 V was applied to flow electrons. At any given time during the voltage application, gas in the oxidation chamber 1 and the reduction chamber 4 were collected, and the reaction products were analyzed using a gas chromatograph and a liquid chromatograph. As a result, it was found that oxygen was formed in the oxidation chamber 1, and hydrogen, carbon monoxide, methane, ethylene, and formic acid were formed in the reduction chamber 4. Furthermore, the current value between the oxidation electrode 2 and the porous reduction electrode 5 during the voltage application was measured by an electrochemical measuring device.

### Example 11

In Example 11, the heating temperature in the third step was set to about 60° C. in the method for constructing a porous electrode-supporting electrolyte membrane according to Example 10. The porosity of the porous reduction electrode 5 was about 94%. Other conditions were all the same as Example 10.

### Example 12

In Example 12, the heating temperature in the third step was set to about 90° C. in the method for constructing a porous electrode-supporting electrolyte membrane according to Example 10. The porosity of the porous reduction electrode 5 was about 94%. Other conditions were all the same as Example 10.

### Example 13

In Example 13, the heating temperature in the third step was set to about 120° C. in the method for constructing a porous electrode-supporting electrolyte membrane according to Example 10. The porosity of the porous reduction electrode 5 was about 94%. Other conditions were all the same as Example 10.

### Example 14

In Example 14, the heating temperature in the third step was set to about 150° C. in the method for constructing a porous electrode-supporting electrolyte membrane according to Example 10. The porosity of the porous reduction electrode 5 was about 94%. Other conditions were all the same as Example 10.

### Example 15

In Example 15, the heating temperature in the third step was set to about 180° C. in the method for constructing a porous electrode-supporting electrolyte membrane according to Example 10. The porosity of the porous reduction electrode 5 was about 94%. Other conditions were all the same as Example 10.

### Example 16

In Examples 16, a copper Celmet with a thickness of about 1.5 mm and a porosity of about 36% was used as the porous metal plate that served as the porous reduction electrode 5 in the constructing method of a porous electrode-supporting electrolyte membrane in Example 10. The heating temperature in the third step was set to about 120° C. The porous reduction electrode 5 after the thermocompression bonding had a thickness of about 1.0 mm and a porosity of about 4%. Other conditions were all the same as Example 10.

### Example 17

In Examples 17, a copper Celmet with a thickness of about 1.5 mm and a porosity of about 56% was used as the porous metal plate that served as the porous reduction electrode 5 in the constructing method of a porous electrode-supporting electrolyte membrane in Example 10. The heating temperature in the third step was set to about 120° C. The porous reduction electrode 5 after the thermocompression bonding had a thickness of about 1.0 mm and a porosity of about 34%. Other conditions were all the same as Example 10.

### Example 18

In Examples 18, a copper Celmet with a thickness of about 1.5 mm and a porosity of about 86% was used as the porous metal plate that served as the porous reduction electrode 5 in the constructing method of a porous electrode-supporting electrolyte membrane in Example 10. The heating temperature in the third step was set to about 120° C. The porous reduction electrode 5 after the thermocompression bonding had a thickness of about 1.0 mm and a porosity of about 64%. Other conditions were all the same as Example 10.

### Comparison Target Example 1

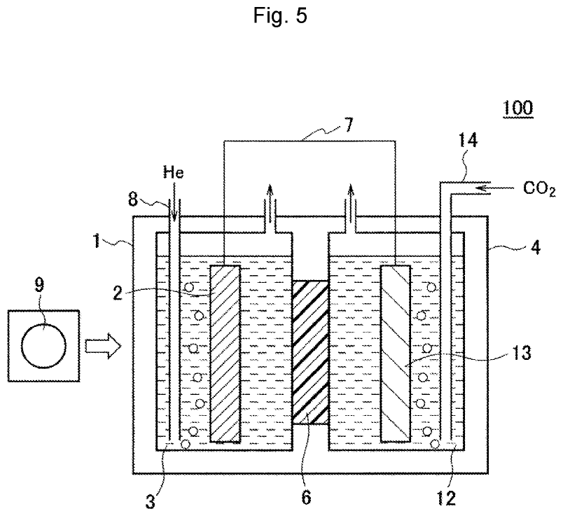

FIG. 5 is a configuration diagram illustrating a constitution of a gas phase reduction apparatus 100 of carbon dioxide according to comparison target example 1. The comparison target example 1 is a comparative example corresponding to Examples 1-9. When the comparison target example 1 is compared with FIG. 1, the oxidation chamber 1 is the same, but the structures of the electrolyte membrane 6 and the reduction chamber 4 are different. The electrolyte membrane 6 is placed between the oxidation chamber 1 and the reduction chamber 4 but is not joined to the reduction electrode. The reduction chamber 4 contains an aqueous solution 12, and the reduction electrode 13 is dipped in the aqueous solution 12. The reduction electrode 13 is a poreless copper plate (manufactured by Nilaco) with an area of about 6 cm². The aqueous solution 3 in the oxidation chamber 1 was a 1-mol/l aqueous potassium hydroxide solution and the solution 12 in the reduction chamber 4 was a 0.5-mol/l aqueous potassium hydrogen carbonate solution. Other constitutions are all the same as Example 1. A tube 14 was inserted into the aqueous solution 12 in the reduction chamber 4, carbon dioxide was then allowed to flow into the aqueous solution 12 from the tube 14, and a reduction reaction of carbon dioxide was caused using liquid phase carbon dioxide. The reaction product was analyzed and found that hydrogen, carbon monoxide, methane, ethylene, and formic acid were formed.

### Comparison Target Example 2

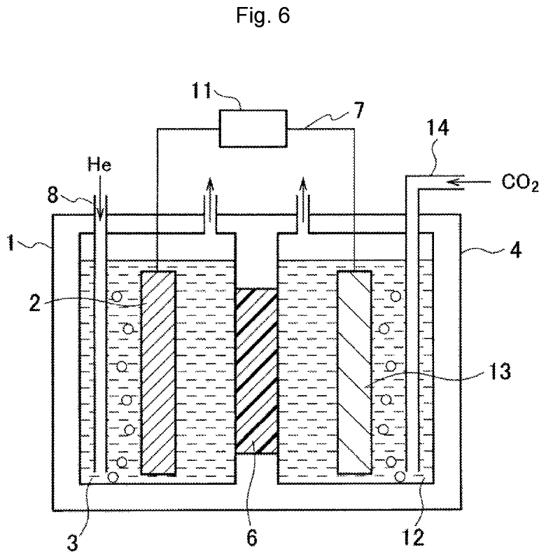

FIG. 6 is a configuration diagram illustrating a gas phase reduction apparatus 100 of carbon dioxide according to comparison target example 2. The comparison target example 2 is a comparative example corresponding to Examples 10-18. When the comparison target example 2 is compared with FIG. 4, the oxidation chamber 1 is the same, but the structures of the electrolyte membrane 6 and the reduction chamber 4 are different. The electrolyte membrane 6 is placed between the oxidation chamber 1 and the reduction chamber 4 but is not joined to the reduction electrode. The reduction chamber 4 contains an aqueous solution 12, and the reduction electrode 13 is dipped in the aqueous solution 12. The reduction electrode 13 is a poreless copper plate (manufactured by Nilaco) with an area of about 6 cm². The aqueous solution 3 in the oxidation chamber 1 was a 1-mol/l aqueous potassium hydroxide solution and the solution 12 in the reduction chamber 4 was a 0.5-mol/l aqueous potassium hydrogen carbonate solution. Other constitutions are all the same as Example 10. A tube 14 was inserted into the aqueous solution 12 in the reduction chamber 4, carbon dioxide was then allowed to flow into the aqueous solution 12 from the tube 14, and a reduction reaction of carbon dioxide was caused using liquid phase carbon dioxide. The reaction product was analyzed and found that hydrogen, carbon monoxide, methane, ethylene, and formic acid were formed.

### Evaluation of Examples and Comparison Target Examples

The following table 1 lists the Faraday efficiencies of carbon dioxide reduction reactions determined on Examples 1-18 and comparison target examples 1 and 2.

TABLE 1

| | Heating | | Faraday Efficiency |
|---|---|---|---|
| | temperature in | | of carbon dioxide |
| | the third step | Porosity | reduction reaction |
| | (° C.) | (%) | (%) |
| Example 1 | 30 | 94 | — |
| Example 2 | 60 | 94 | 33 |
| Example 3 | 90 | 94 | 34 |
| Example 4 | 120 | 4 | 34 |
| Example 5 | 150 | 94 | 33 |
| Example 6 | 180 | 94 | — |
| Example 7 | 120 | 4 | 22 |
| Example 8 | 120 | 34 | 27 |
| Example 9 | 120 | 64 | 32 |
| Example 10 | 30 | 94 | — |
| Example 11 | 60 | 94 | 30 |
| Example 12 | 90 | 94 | 30 |
| Example 13 | 120 | 94 | 31 |
| Example 14 | 150 | 94 | 31 |
| Example 15 | 180 | 94 | — |
| Example 16 | 120 | 4 | 18 |
| Example 17 | 120 | 34 | 24 |
| Example 18 | 120 | 64 | 29 |
| Comparison target | — | — | 2 |
| example 1 | | | |
| Comparison target | — | — | 10 |
| example 2 | | | |

Faraday efficiency means a proportion of a current value used in each reduction reaction with respect to a current value flown between electrodes upon light irradiation or voltage application, as represented by the formula (2).

[Faraday efficiency of each reduction reaction]=(current value in each reduction reaction)/(current value between oxidation electrode and reduction electrode) (2)

Here, the “current value in each reduction reaction” in the formula (2) can be determined by converting the measured value of the formed amount of each reduction product into the number of electrons required for the formation reaction. When the concentration of a reduction reaction product was taken as A [ppm], the flow rate of the carrier gas was taken as B [L/sec], the number of electrons required for a reduction reaction was taken as Z [mol], the Faraday constant was taken as F [C/mol], and the molar volume of gas was taken as Vm [L/mol], the “current value in each reduction reaction” was calculated using the formula (3).

[Current value in each reduction reaction] [A]=(A×B×Z×F×10⁻⁶)/Vm (3)

In Table 1, the measurement results are omitted because electrolyte membranes were separated from the porous reduction electrodes after the thermocompression bonding in Examples 1 and 10. It is considered that this is because the volatilization of the solvent from the electrolyte membrane 6 became insufficient and the joining material 30 did not harden due to the low heating temperature in the third step in the construction method of the porous electrode-supporting electrolyte membrane 20, and therefore, the adhesiveness between the electrolyte membrane 6 and the porous reduction electrode 5 became low. In Examples 6 and 15, the current did not flow between the oxidation electrode and the reduction electrode even upon light irradiation or voltage application. It is considered that this is because the sulfonic acid group that formed the electrolyte membrane was decomposed due to the high heating temperature in the third step, and the electrolyte membrane lost the ion exchange function. Therefore, it is considered that the heating temperature in the third step is preferably 60° C. or higher and 150° C. or lower.

Furthermore, compared with the comparison target examples 1 and 2, the Faraday efficiencies of carbon dioxide reductions were enhanced in Examples 2-5 and 7-9, and Examples 11-14 and 16-18. Thus, it is found that the reduction reaction of carbon dioxide selectively occurs in Examples 2-5 and 7-9, and Examples 11-14 and 16-18. It is considered that this is because carbon dioxide near the copper surface increased and the diffusion resistance of carbon dioxide was lowered due to direct supply of gas phase carbon dioxide to the copper porous reduction electrode 5 without via an aqueous solution in Examples 2-5 and 7-9, and Examples 11-14 and 16-18, and the supply amount of carbon dioxide to copper increased.

### Effect of Examples

According to Examples 1 to 10, gas phase carbon dioxide is directly supplied to the porous electrode-supporting electrolyte membrane 20 in which the porous reduction electrode 5 is joined to the electrolyte membrane 6. Thus, the increase of the concentration of carbon dioxide in the reduction chamber and the reduction of the diffusion resistance of carbon dioxide near the reduction electrode surface are possible, and the enhancement of the efficiency of the reduction reaction of carbon dioxide on the reduction electrode can be achieved.

### REFERENCE SIGNS LIST

1 Oxidation chamber

2 Oxidation electrode

3 Aqueous solution

4 Reduction chamber

5 Porous reduction electrode

6 Electrolyte membrane

7 Conductor

8 Tube

9 Light source

10 Gas inlet

11 Power source

12 Aqueous solution

13 Reduction electrode

14 Tube

20 Porous electrode-supporting electrolyte membrane

30 Joining material

40a, 40b Copper plate

100 Gas phase reduction apparatus of carbon dioxide

1. A gas phase reduction apparatus of carbon dioxide, comprising:
an oxidation chamber that includes an oxidation electrode;
a reduction chamber that is adjacent to the oxidation chamber and receives supplied carbon dioxide; and
a porous electrode-supporting electrolyte membrane that is placed between the oxidation chamber and the reduction chamber,
the porous electrode-supporting electrolyte membrane being
a joined body including a porous reduction electrode joined to an electrolyte membrane, the electrolyte membrane being placed on a side of the oxidation chamber, the porous reduction electrode being placed on a side of the reduction chamber and configured to reduce the carbon dioxide by electrons from the oxidation electrode connected via a conductor.

2. The gas phase reduction apparatus of carbon dioxide according to claim 1, further comprising:
a light source for irradiating the oxidation electrode with light.

3. The gas phase reduction apparatus of carbon dioxide according to claim 1, further comprising:
a power source connected to the conductor.

4. The gas phase reduction apparatus of carbon dioxide according to claim 1, wherein
the oxidation electrode is an n-type semiconductor.

5. A method for producing a porous electrode-supporting electrolyte membrane used in a gas phase reduction apparatus of carbon dioxide,
the gas phase reduction apparatus of carbon dioxide including:
an oxidation chamber that includes an oxidation electrode;
a reduction chamber that is adjacent to the oxidation chamber and receives supplied carbon dioxide; and
a porous electrode-supporting electrolyte membrane that is placed between the oxidation chamber and the reduction chamber,
the porous electrode-supporting electrolyte membrane being
a joined body including a porous reduction electrode joined to an electrolyte membrane, the electrolyte membrane being placed on a side of the oxidation chamber, the porous reduction electrode being placed on a side of the reduction chamber and configured to reduce the carbon dioxide by electrons from the oxidation electrode connected via a conductor,
the method comprising:
a first step of coating an electrolyte dispersion on a surface of the electrolyte membrane;
a second step of thermally treating the electrolyte dispersion to form a joining material of an identical component to the electrolyte membrane on a surface of the electrolyte membrane; and
a third step of superimposing the porous reduction electrode on a surface of the joining material and applying pressure on the porous reduction electrode while heating such that the electrolyte membrane and the porous reduction are joined together.

6. The method for producing a porous electrode-supporting electrolyte membrane according to claim 5, wherein,
in the third step,
the pressure is applied to the porous reduction electrode while the porous reduction electrode is heated at a temperature of 60° C. or higher and 150° C. or lower.

7. The gas phase reduction apparatus of carbon dioxide according to claim 2, wherein
the oxidation electrode is an n-type semiconductor.
